(19) United States
(12) Patent Application Publication
(10) Pub. No.: US 2016/0052223 A1
(43) Pub. Date: Feb. 25, 2016

(54) Profile Based Structural Material Core, Structural Material and Production Method

(71) Applicants: Alexis CHERMANT, (US); Frédéric BRUN, (US)

(72) Inventor: Frederic Brun, Caen (FR)

(21) Appl. No.: 14/774,360

(22) PCT Filed: Mar. 5, 2014
(86) PCT No.: PCT/FR2014/050493

§ 371 Date: Sep. 10, 2015

(30) Foreign Application Priority Data
Mar. 11, 2013 (FR) 13 52144

(51) Int. Cl. B32B 3/12; B32B 37/00; B32B 37/10; B32B 15/20

(52) U.S. Cl. CPC B32B 3/12; B32B 15/20; B32B 37/0053; B32B 37/10; B32B 2605/08; B32B 2605/18; B32B 2307/56; B32B 2307/542; B32B 2307/558

(57) ABSTRACT

The invention relates to a sandwich structural material core, where said core comprises a honeycomb structure, with hexagonal cells, where the hexagonal cells comprise at least two adjacent sides connected by an edge, where the two adjacent sides have a first length and each comprise a corrugated area, one among said two adjacent sides being the image of the other adjacent side by rotation through an angle around said edge, and also where at least one of said parallel sides has a second length and is substantially flat. The first length is substantially included between 80 and 120% of said second length.

The present invention relates to structural material course, structural materials comprising such a core and methods with which to fabricate such a core.

Structural sandwich structural materials are generally composed of two outer skins rigidly connected onto the opposite surfaces of a core. Said core can be made of a wide variety of constituent materials and is made in such a way that it has a high structural resistance to compression and bending while keeping a minimal weight. These structural materials have many applications, for example in the aeronautic or automobile domain.

Among these materials, the best-known are those comprising a honeycomb core. These cores are constituted of sheets shaped and then attached at precise points in order to constitute a network of hexagonal profile cells, sometimes deformed, extending perpendicularly to said outside skins. Many materials can be used for implementing this core, for example cardboard, aluminum, plastic, composite materials or metals.

The advantage of such materials is to have a structure which is at once both strong and lightweight.

Various geometric models have been created and the proposed improvements mainly cover the following properties:
Ease of shaping (cylindrical or spherical bending);
Energy absorption;
Improvement of general mechanical property;
Improvement of mechanical properties under shearing in the W direction.

However, from the state-of-the-art it can be observed that none of the proposed models simultaneously satisfies all these criteria. The main mechanical properties, specifically the compressive strength, sharing strength in the L direction and in the W direction play on the connecting vases according to the selected cellular geometric configuration: the increase of one of them is seen as a decrease of one or more of the others jointly, when considering a constant density.

The object of the invention is to propose a structural material core which has both an ease of shaping and mechanical properties at least as good as those that can be obtained today with honeycomb-type hexagonal-cellular structures.

### TECHNOLOGICAL BACKGROUND

From the U.S. Pat. No. 5,431,980 structural material cores are known which can be used to create walls that are at once rigid, light and curved.

To do that, the document provides in particular a structural material core which comprises honeycomb-shaped cells where said cells have sides with specific shapes, of the type with corrugated shapes, of semicircle drawings, etc.

The cores are made from corrugated strips superposed on each other and connected to each other point-wise by attachment areas. The corrugated strips have a motif repeated over their entire length and the motif comprises a flat area alternating with a corrugated area. The flat areas of each corrugated strip are alternately attached either to a flat area of an upper corrugated strip or to a flat area of a lower corrugated strip. Additionally, the material core can be fanned-out between a compact state and a fanned-out state by expansion of the superposed corrugated strips along a direction perpendicular to the direction of said superposed corrugated strips.

From documents WO 88/06970 or WO 94/17993 sandwich structural material cores are known which extend substantially along extension directions (X, Y) and are intended to be included between a lower surface and an upper surface, which are opposite along a thickness direction, where said core comprises a honeycomb structure with substantially regular-hexagonal cells and where the cells comprise:
at least two adjacent sides connected by an edge, where the two adjacent sides have a first length and each comprises a corrugated area; and
at least two parallel sides having a second length and being substantially flat.

### SUBJECT OF THE INVENTION

The subject matter of the invention is a cellular-type structural material core described in U.S. Pat. No. 5,431,980 that has better mechanical properties and especially better stiffness.

To do that, the invention in the first instance concerns a sandwich structural material core, such as defined above with respect to documents WO 88/06970 or WO 94/17993, meaning a core which extends substantially along the extension directions (X, Y) and which is intended to be included between a lower surface and an upper surface, opposite along a thickness direction, where said core comprises a honeycomb structure, of substantially regular-hexagonal cells, the cells comprising two adjacent sides connected by an edge, having a first length and comprising a corrugated area, and also two parallel sides having a second length and being substantially flat.

According to the invention, the core is remarkable in that, concerning the two adjacent sides (having corrugated areas), one is the image of the other by rotation through a certain angle around the edge which connects the two adjacent sides.

Additionally, conforming to the invention, said first length is substantially included between 80 and 120% of said second length.

“Length” is understood to mean the shortest distance between two edges of the hexagonal cell.

The fact of having cells whose sides have lengths such as defined above makes it possible to have a better stiffness while allowing an adaptation of the core to curved or spherical shapes.

The fact of having corrugated adjacent sides which are images of each other by rotation around an edge which connects them makes it possible to superpose the two adjacent-sides one on the other in a compact configuration of the core. Thus the resulting compacted core is substantially flat, at the very least thin, and is therefore low bulk.

The core of structural material conforming to the invention can just the same be made in different ways.

It can, for example, be molded.

It can also be made in the form of a laminated structure which can be fanned-out, which thus makes it easily transportable because it has a small bulk.

To do this, the honeycomb core structure conforming to the invention can comprise corrugated strips superposed on each other and connected point-wise to each other by attachment areas, where said corrugated strips have a motif repeated on their entire length, where said motif comprises a flat area alternating with a corrugated area, where said flat areas from each corrugated strip are alternately attached either to a flat area of an upper corrugated strip or to a flat area of a lower corrugated strip, and where said material core can be fanned-out between a compact state and a fanned-out state by expansion of the superposed corrugated strips along the direction perpendicular to the direction of said superposed corrugated strips. In this case, in fanned-out position, (i) the corrugated strips attached to each other form the two said adjacent sides comprising the corrugated areas, and (ii) the two flat substantially parallel sides are formed by two flat areas of two superposed corrugated strips.

The core conforming to the invention can also comprise the following properties, taken separately or in combination:
said corrugated area can have a zigzag pattern comprising at least two humps;
said at least two humps from the zigzag pattern can each have a pointed summit. Such an embodiment, combined with the implementation of the core in the initial shape of a structure that can be fanned-out, serves to make a laminated structure that can be fanned-out from a small thickness because the zigzag shapes with pointed summits provide for a better nesting of the corrugated strips into each other (this in comparison to the nesting of the corrugated strips whose corrugation shapes are half circles, for example the shapes described in the examples from U.S. Pat. No. 5,431,980); and
said honeycomb structure can be made of an aluminum alloy.

Secondly, the invention targets a sandwich structural material comprising a core such as defined above, where said core is attached to at least one outer skin.

Thirdly, the invention also targets a production method for a sandwich structural material core as defined above.

The method includes the following steps:
a first step of passing a strip of deformable material between two rollers;
a second step of die stamping of said strip to make a succession of equidistant corrugated areas and flat areas on said strip, so as to result in a corrugated strip;
a third step of making a first upper corrugated strip rigidly connected to a second lower corrugated strip by attachment of one flat area out of two between said upper corrugated strip and said lower corrugated strip;
a fourth step of rigidly connecting another additional corrugated strip to the already rigidly connected corrugated strips by attachment of the flat areas of the additional corrugated strip to the flat areas of the upper corrugated strip which were not attached to the flat areas of the lower corrugated strip; and
a possible repetition of the fourth step several times so as to obtain a laminated structure comprising a set number of corrugated strips rigidly connected to each other.

The method conforming to the invention can also comprise the following features:
It can comprise an additional step according to which the structure is fanned-out by extending the superposed and rigidly connected corrugated strips along a direction perpendicular to the direction of the strips;
It can furthermore comprise an additional step of dipping said fanned-out structure in a resin;
It can finally comprise an additional step of curing the fanned-out structure after the dipping step, so as to stiffen the fanned-out structure.

### BRIEF DESCRIPTION OF THE DRAWINGS

In order to be able to be executed, the invention is disclosed sufficiently clearly and completely in the following description which is, additionally, accompanied by drawings in which:

FIG. 1 partially shows a structural material core in compacted position, perspective view and substantially from above;

FIG. 2 shows the structural material core from FIG. 1, in compacted position, entirely shown and seen in perspective in lengthwise position;

FIG. 3 shows the core illustrated in FIGS. 1 and 2, in fanned-out position, seen in perspective; and

FIG. 4 is a top view of the core shown in FIG. 3 fanned-out.

### DETAILED DESCRIPTION

In the following description, the terms “lower”, “upper”, “top”, “bottom”, etc. are used with reference to the drawings to make understanding easier. They must not be understood as limitations on the scope of the invention.

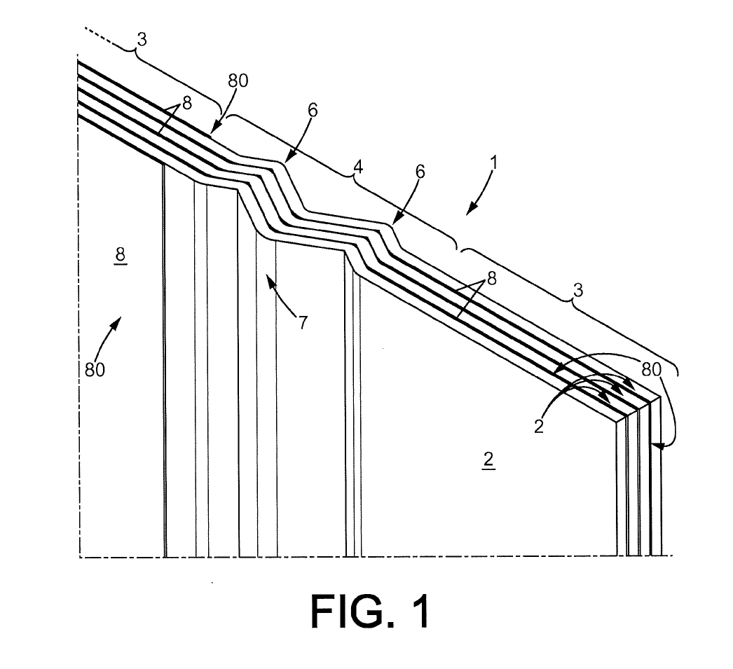

FIG. 1 only shows a portion of core 1 conforming to the invention, deliberately, so as to clearly distinguish the various elements that comprise the core 1.

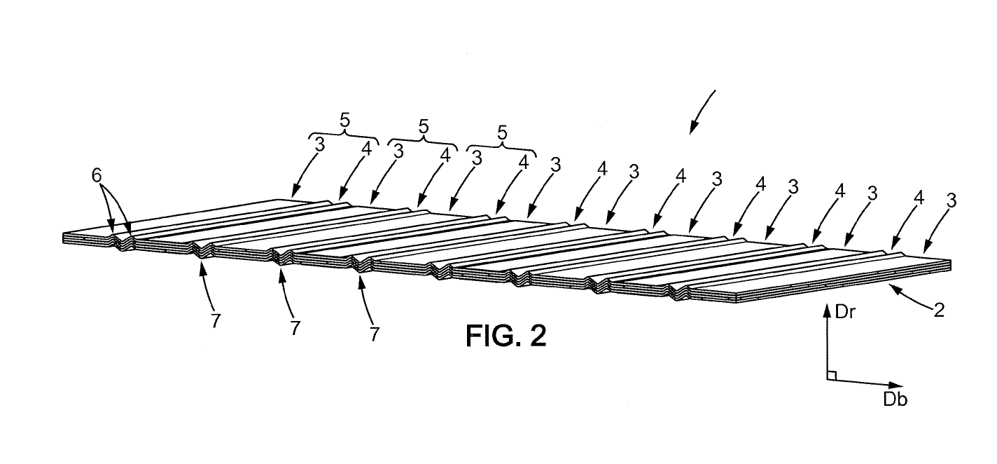

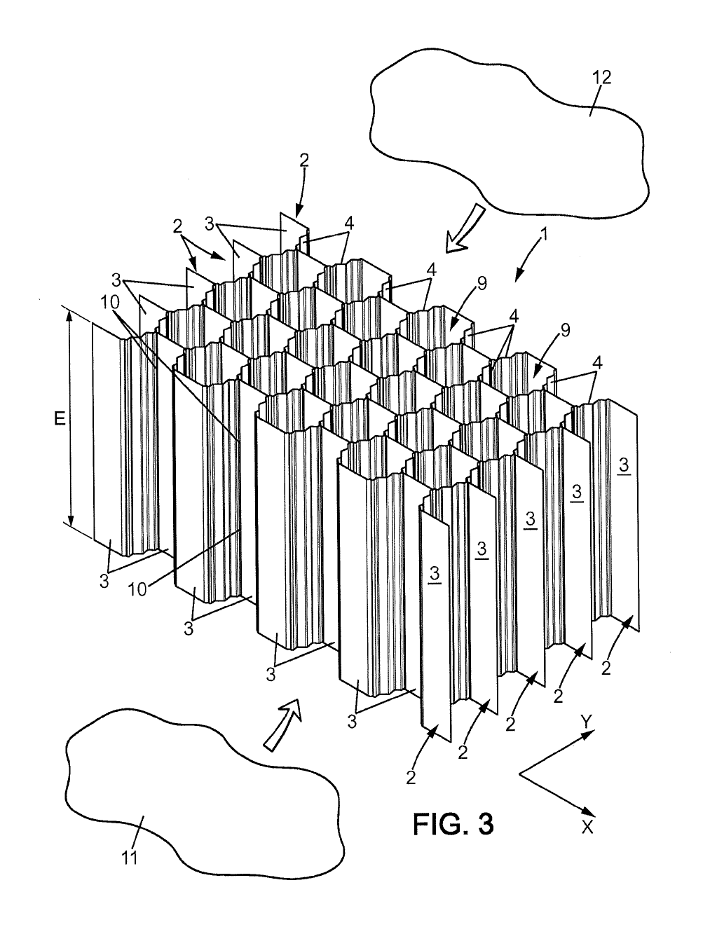

The core 1 is shown in its entirety, in compact position, in FIG. 2, and in fanned-out position in FIG. 3.

In the implementation example shown in FIGS. 1 and 2, the core 1 comprises four corrugated strips 2. In the example shown in FIG. 3, the core 1 comprises five strips.

Thus, a structural material core conforming to the invention is not limited to the presence of a particular quantity of corrugated strips 2.

Thus it has to be understood that the core 1 could comprise more than five corrugated strips 2 or less than four corrugated strips 2 without going outside the context of the invention.

In the context of this embodiment, the corrugated strips 2 are strips of aluminum alloy metal.

It also has to be understood that the core could be made of another material, malleable or not, without going outside the context of the invention.

In fact, in the example shown, the core is implemented from strips which are initially superposed and connected to each other, and then fanned-out by expansion of the structure.

Hence, the invention could also apply to the implementation of a molded core, comprising all the features conforming to the invention and such as defined later.

As FIGS. 1 and 2 show, the corrugated strips 2 are superposed one upon the other.

Each of the corrugated strips 2 comprises, alternately, a flat area 3 and a corrugated area 4. A flat area 3 followed by a corrugated area 4 forms a motif 5 which is thus repeated over the full length of the corrugated strip 2 (see FIG. 2).

Each corrugated area 4 has a zigzag motif with three changes of direction. In other words, each zigzag motif has two humps 6 oriented to one side of the strip 2 and one humps 7 oriented to the other side of the strip 2.

Also observe that that the humps 6 and 7 have pointed summits.

With this configuration of the zigzag areas, the corrugated strips 2 can be superposed very close to each other.

In other words, because of the particular shape of the corrugated areas, the superposed corrugated strips 2 form a very thin multilayer assembly, such that once the corrugated strips 2 are stacked, the corrugated areas 4 do not result in a spacing of two superposed corrugated strips 2 which is greater than the thickness of glue 8 in the area of the flat areas 3. This glue thickness is substantially a few microns.

Thus, in order to form the core 1, the corrugated strips 2 are connected by application of a thickness of glue which is done on the flat areas 4 in the following way:

As can be seen in FIG. 1, the corrugated strip 2 has a thickness of glue on each of the flat areas 3 thereof, but one time the thickness of glue is deposited on the flat area 3, one time it is deposited on the flat area 3.

In other words, the flat areas 3 of corrugated strip 2 are alternately attached either to a flat area 3 of an upper corrugated strip 2 or to a flat area 3 of a lower corrugated strip 2.

The areas on which a thickness of glue 8 is deposited are called the attachment areas 80.

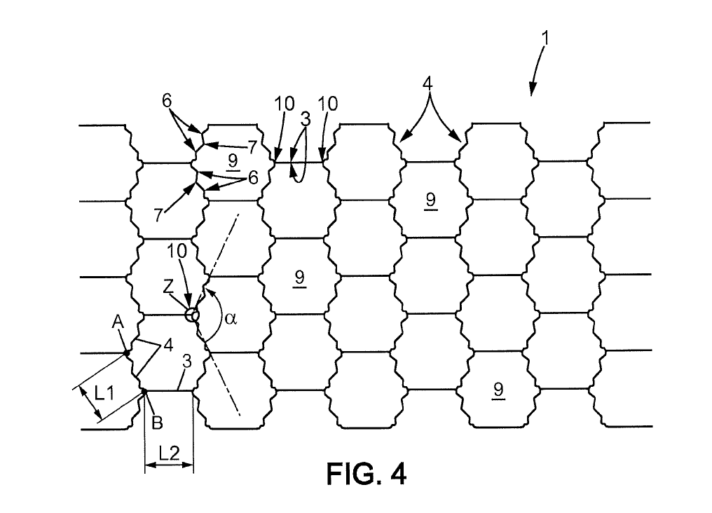

In order to change from the compact position (or state) shown in FIGS. 1 and 2 to the fanned-out position (or state) shown in FIGS. 3 and 4, the corrugated strips are expanded. This expansion is done by pulling on the corrugated strips along a direction Dr which is perpendicular to the direction Db of the corrugated strips. The directions Db and Dr are visible in FIG. 2. In performing this operation, the corrugated areas 4 rotate around the Z axis.

Thus in fanned-out position shown in FIG. 3 or 4, the corrugated strips 2 are attached to each other and they form a network of cells 9 that are substantially hexagonal of honeycomb type. The material core 1 extends substantially along two directions X and Y shown in FIG. 3.

Thus each cell comprises six sides, which are substantially parallel pairwise.

Among the six sides, at least two sides are formed by corrugated areas 4 of the corrugated strips 2 and two sides are flat and are formed by flat areas 3 of the corrugated strips 2.

Two adjacent sides 4, formed by two corrugated areas from two corrugated strips superposed and connected to each other, therefore each comprise one corrugated area and have a first length L1.

The length L1 is shown in FIG. 4 and is the shortest distance taken between the two ends A and B of an adjacent side 4 having a corrugated area.

Additionally it should be noted, on FIG. 4, that the adjacent corrugated sides formed by the corrugated areas 4 are symmetric by revolution (or rotation) through an angle α around the edge 10 (or of the Z axis along which the edge 10 extends), where the edge 10 connects the two adjacent corrugated sides.

Concretely, that means that for two adjacent sides formed by corrugated areas 4, one of the sides has two humps 6 towards the outside of the cell 9 and the other adjacent side has two humps 6 towards the inside of the cell.

The two sides of the hexagonal cell 9 which are contiguous to the two adjacent sides are two parallel sides formed by the flat areas 3 of the strips 2.

The two parallel and flat sides have a length L2.

Note on FIG. 4 that the lengths of the sides L1 and L2 are substantially identical. Thus conforming to the invention, the first length L1 is included between 80 and 120% of the second length L2.

As can be seen in FIG. 3, the core 1 is intended to be included between a lower surface 11 and an upper surface 12 where the surfaces 11 and 12 are on opposite sides along the thickness direction E.

To simplify the reading of the figures, the surfaces 11 and 12 are partially shown. It can involve thin plates, called skin, like for example those described in the document WO 2007/137607 (in this document the skins have the reference 8 and the core has the reference 2).

Reference is now going to be made to a fabrication method for the core 1 which was just presented.

Initially, there are strips of deformable material of aluminum alloy which are precut.

The first step of the method consists of sending a band of deformable material between two rollers in order to flatten the band such that it has a constant thickness at every point.

Each strip is then die stamped, according to a die stamping step. The die stamping step is used to make the corrugated areas on the strip of deformable material at regular intervals. A corrugated strip 2 thus results.

The die stamping can be done by any die stamping method known to the person skilled in the art. For example, the strips can be regularly pressed, drawn or shaped continuously by passing between two rollers having teeth suited for giving a specific shape point-by-point on the strips.

According to a third step from the method, several corrugated strips 2 are made rigidly connected to each other.

To do that, a thickness of glue 8 is applied on every other flat area 3 of a first corrugated strip 2.

And then, a second corrugated strip 2 is placed on the first corrugated strip 2 coated with glue 8.

On this second corrugated strip, a thickness of glue is also applied on the flat areas 3, however, the flat areas 3 on which the thicknesses of glue 8 are applied are not the same as those already rigidly connected by a thickness of glue 8 to the flat areas 3 of the first corrugated strip 2.

Then a third strip is superimposed on the second strip. And so on, until a compact core comprising the desired number of corrugated strips results.

The core, in the resulting compact shape thereof, is very low bulk because of its small thickness. In this way large quantities can be stored with some benefit because it serves to limit the transportation costs.

The core according to the invention can also undergo additional method steps in order to give it the fanned-out shape thereof.

To do that, after having made a core in the compact form thereof as described above, the method provides for fanning-out the structure by extending the corrugated strips 2, which are superposed and rigidly connected to each other, along the direction Dr which is perpendicular to the direction Db of the corrugated strips.

This expansion can be done mechanically by holding the corrugated strip 2 from the bottom of the core 1 and by pulling on the corrugated strip 2 from the top of the core 1.

Other methods known to the person skilled in the art could also be implemented without going outside the context of the invention.

Once a core in the fanned-out form results, the method can provide for fixing the core in the resulting shape. In fact, if the core is not fixed in the fanned-out form, it can be compacted again.

To keep it in the fanned-out shape thereof, the method provides for a step according to which the fanned-out structure is dipped in resin and then a final step according to which the resin-coded fanned-out structure is passed through an oven in order to cure the resin.

From the preceding description it is understood how the invention serves to implement a core which, in the compact form thereof, is very thin and therefore low bulk. It is also clearly understood that the shapes of the corrugated areas are what make this advantage possible.

When the shapes of the corrugated areas are combined with ratios of lengths L1 and L2 such as previously defined, the core has better strength and flexibility performance.

However it needs to be understood that the invention is not limited to the previously described examples and that it targets any equivalent implementation.

1. A structural sandwich material core extending substantially along extension directions and intended to be included between a lower surface and an upper surface, which are opposite along a thickness direction, where said core comprises a honeycomb structure with substantially regular-hexagonal cells, the cells comprising:
at least two adjacent sides connected by an edge, where the two adjacent sides have a first length and each comprises a corrugated area;
and also at least two parallel sides having a second length and being substantially flat,
wherein:
one among said two adjacent sides is the image of the other adjacent sides by rotation through an angle around said edge, and
said first length is substantially included between 80 and 120% of said second length.

2. The structural material core according to claim 1, wherein the honeycomb structure comprises corrugated strips superposed on each other and connected point-wise to each other by attachment areas, where said corrugated strips have a motif repeated on their entire length, where said motif comprises a flat area alternating with a corrugated area, where said flat areas from each corrugated strip are alternately attached either to a flat area of an upper corrugated strip or to a flat area of a lower corrugated strip, and where said material core can be fanned-out between a compact state and a fanned-out state by expansion of the superposed corrugated strips along a direction perpendicular to the direction of said superposed corrugated strips, such that in fanned-out state the corrugated strips attached to each other form the two said adjacent sides comprising the corrugated zones and so that the two flat substantially parallel sides are formed by two flat areas of two superposed corrugated strips.

3. The core according to claim 1, wherein said corrugated area can have a zigzag motif comprising at least two humps.

4. The core according to claim 3, wherein said at least two humps from the zigzag motif each have a pointed summit.

5. The core according to claim 1, wherein said honeycomb structure can be made of an aluminum alloy.

6. A sandwich structural material comprising a core according to claim 1, where said core is attached to at least one outer skin.

7. A fabrication method for sandwich structural material core according to claim 2, comprising the following steps:
a first step of passing a strip of deformable material between two rollers;
a second step of die stamping of said strip to make a succession of equidistant corrugated areas and flat areas on said corrugated strip, so as to result in a corrugated strip;
a third step of making a first upper corrugated strip rigidly connected to a second lower corrugated strip by attachment of a flat area on both said upper corrugated strip and said lower corrugated strip;
a fourth step of rigidly connecting another additional corrugated strip to the already rigidly connected corrugated strips by attachment of the flat areas of the additional corrugated strip to the flat areas of the upper corrugated strip which were not attached to the flat areas of the lower corrugated strip;
a possible repetition of the fourth step several times so as to obtain a laminated structure comprising a set number of corrugated strips rigidly connected to each other.

8. The method according to claim 7, wherein it comprises an additional step according to which the structure is deployed by extending the superposed and them rigidly connected corrugated strips along a direction perpendicular to the direction of the strips.

9. The method according to claim 8, wherein it comprises an additional step of dipping said deployed structure in a resin.

10. The method according to claim 9, wherein it comprises an additional step of curing the deployed structure after the dipping step, so as to stiffen the deployed structure.
